(19) United States
(12) Patent Application Publication
(10) Pub. No.: US 2010/0318706 A1
(43) Pub. Date: Dec. 16, 2010

(54) BUS ARBITRATION CIRCUIT AND BUS ARBITRATION METHOD

(75) Inventor: Kazuyuki KOBAYASHI, Kawasaki (JP)

Correspondence Address: SUGHRUE MION, PLLC, 2100 PENNSYLVANIA AVENUE, N.W., SUITE 800, WASHINGTON, DC, 20037, US

(73) Assignee: NEC Electronics Corporation, Kawasaki (JP)

(21) Appl. No.: 12/778,204

(22) Filed: May 12, 2010

(30) Foreign Application Priority Data
Jun. 10, 2009 (JP) 2009-139265

(51) Int. Cl. G06F 13/364

(52) U.S. Cl. 710/114

(57) ABSTRACT

Provided is a bus arbitration circuit including: a fixed priority determination circuit that grants a bus use right to an access request from a higher priority bus master among access requests from a plurality of bus masters; and a determination adjustment circuit that determines whether or not to assert the access request from the plurality of bus masters to the fixed priority determination circuit. The determination adjustment circuit masks an access request from a bus master which is granted the bus use right, for a given period of time, when the access request from the bus master which is granted the bus use right and an access request from a bus master which is not granted the bus use right compete with each other.

### INCORPORATION BY REFERENCE

This application is based upon and claims the benefit of priority from Japanese patent application No. 2009-139265, filed on Jun. 10, 2009, the disclosure of which is incorporated herein in its entirety by reference.

### BACKGROUND

1. Field of the Invention

The present invention relates to a bus arbitration circuit and a bus arbitration method, and more particularly, to a bus arbitration circuit and a bus arbitration method that arbitrate bus access requests from multiple bus masters.

2. Description of Related Art

In a data processing system that processes various data, multiple devices are connected in common to a single bus, and a specific device occupies the bus to perform bus access such as data transfer. The data processing system is provided with a bus arbitration circuit. The bus arbitration circuit arbitrates bus access requests from the devices and grants a bus use right for using the bus. A device that requests a bus access to the bus arbitration circuit and obtains the bus use right is referred to as a bus master.

For example, in a system in which multiple bus masters exist and the bus masters access a single resource (bus slave), such as a CPU bus for connecting multiple CPUs to each other and a DMA transfer bus for connecting multiple DMAs (Direct Memory Accesses) to each other, the bus arbitration circuit arbitrates bus access requests from the bus masters in accordance with a predetermined method and allocates the bus use right to the bus masters.

FIG. 6 is a diagram showing a system circuit including multiple bus masters. When first to third bus masters 104, 105, and 106 access a bus slave 107, the circuit shown in FIG. 6 asserts a bus request (BUSRQn:n=1-3) to a bus arbitration circuit 101 so as to acquire a bus use right. The bus arbitration circuit 101 receiving the bus request asserts a bus use grant (BUSAKn:n=1-3) in accordance with a predetermined arbitration rule. Then, the bus master receiving the bus use grant executes access to the bus slave 107.

As methods for the bus arbitration circuit to arbitrate bus access requests, there are known a fixed priority method and a round robin method (see Japanese Unexamined Patent Application Publication No. 2007-26022). The fixed priority method is a method in which when bus requests from multiple bus masters compete with each other, a bus service is executed in the order from a higher priority bus master. Meanwhile, the round robin method is a method in which the bus use right is granted evenly to the bus masters in a predetermined order and the bus master which has been granted the bus service once is set to the lowest priority level.

FIG. 7 is a diagram illustrating the operation of the bus arbitration circuit 101 that arbitrates bus accesses among the three bus masters 104, 105, and 106 shown in FIG. 6 in accordance with the fixed priority method. In this case, the priority is set in the order of the first bus master 104 (high priority), the second bus master 105 (medium priority), and the third bus master 106 (low priority), and the priority order is fixed. A period of time after the reception of the bus use grant until the assertion of a subsequent bus request (i.e., a period of time indicated by each arrow of FIG. 7) is a constant period. BUSRQn (n=1-3) shown in FIG. 7 represents a bus request from each of the bus masters 104, 105, and 106, and BUSAKn (n=1-3) represents a bus use grant from the bus arbitration circuit 101. Each of M1 to M3 shown in BUSIF of FIG. 7 represents a bus master accessing the bus slave 107. Specifically, M1 represents the first bus master 104, M2 represents the second bus master 105, and M3 represents the third bus master 106. In FIG. 7, a high level represents an active level.

Referring to FIG. 7, at a timing T1, all the bus masters 104, 105, and 106 assert bus requests (BUSRQ1-BUSRQ3) simultaneously. At a timing T2, the first bus master 104 of high priority starts to access the bus slave 107. At a timing T3, the second bus master 105 of medium priority starts to access the bus slave 107. At a timing T4, the first bus master 104 of high priority starts to access the bus slave 107 again. At a timing T5, the third bus master 106 of low priority starts to access the bus slave 107. At a timing T6, the first bus master of high priority starts to access the bus slave 107 (five periods in succession). At a timing T7, the second bus master 105 of medium priority starts to access the bus slave 107 (three periods in succession). At a timing T8, the first bus master 104 of high priority starts to access the bus slave 107 (three periods in succession). At a timing T9, the second bus master 105 of medium priority starts to access the bus slave 107.

Thus, in the fixed priority method, when the bus requests from the multiple bus masters 104, 105, and 106 compete with each other, the bus service is executed in the order from a higher priority bus master.

FIG. 8 is a diagram illustrating the operation of the bus arbitration circuit 101 that arbitrates the bus accesses from the three bus masters 104, 105, and 106 shown in FIG. 6 in accordance with the round robin method. In this case, the priority is initially set in the order of the first bus master 104 (high priority), the second bus master 105 (medium priority), and the third bus master 106 (low priority). The bus master that has asserted the bus use grant once is reset to the lowest priority level. A period of time after the reception of the bus use grant until the assertion of a subsequent bus request (i.e., a period of time indicated by each arrow of FIG. 8) is a constant period. In FIG. 8, a high level represents an active level.

As shown in FIG. 8, at the timing T1, all the bus masters 104, 105, and 106 assert bus requests simultaneously. At the timing T2, the first bust master 104 of high priority starts to access the bus slave 107, and the first bus master 104 shifts to the lowest priority level. At this time, the priority is set in the order of the second bus master 105, the third bus master 106, and the first bus master 104. At the timing T3, the second bus master 105 of high priority starts to access the bus slave 107, and the second bus master 105 shifts to the lowest priority level. At this time, the priority is set in the order of the third bus master 106, the first bus master 104, and the second bus master 105. At the timing T4, the third bus master 106 of high priority starts to access the bus slave 107, and the third bus master 106 shifts to the low priority level. At this time, the priority is set again in the order of the first bus master 104, the second bus master 105, and the third bus master 106. After that, at the timings T5 to T8, similar operations are repeated.

In addition, Japanese Unexamined Patent Application Publication No. 07-175714 discloses a bus arbitration circuit capable of granting a bus use right also to a bus master of low priority even when a bus request is frequently issued from a bus master of high priority. In this technique, the bus arbitration is achieved by taking into consideration a bus use time and a bus request cycle of each bus master when the bus requests compete with each other.

### SUMMARY

The present inventor has found problems as described below. In the fixed priority method described in the description of related art section, the bus use right is always granted to a bus request from a bus master of high priority during the bus arbitration. Accordingly, if the bus master of high priority continuously issues bus requests, the bus use right for a bus master of low priority cannot be easily granted. As a result, the bus use grant period for the bus master of low priority is insufficient, which causes problems such as deterioration in system performance and a failure of a system configuration.

Further, in the round robin method described in the description of related art section, the bus master that has been granted a bus use right is set to the lowest priority level in the subsequent arbitration processing. Thus, the bus use right is granted evenly to all the bus masters without consideration of the priority order of the bus masters. As a result, the bus use grant period for the bus master to be set to the high priority level is insufficient, which causes problems such as deterioration in system performance and a failure of a system configuration.

Moreover, in the bus arbitration circuit disclosed in Japanese Unexamined Patent Application Publication No. 07-175714, the bus cycle of each bus master is constant and the cycle in which a bus request occurs needs to be fixed. This causes a problem that it is impossible to achieve an optimal bus use grant for complicated bus cycles and complicated bus requests, for example, in the case where the periods of bus requests from bus masters and the bus request cycles are irregular.

A first exemplary aspect of the present invention is a bus arbitration circuit including: a fixed priority determination circuit that grants a bus use right to an access request from a higher priority bus master among access requests from a plurality of bus masters; and a determination adjustment circuit that determines whether or not to assert the access request from the plurality of bus masters to the fixed priority determination circuit. The determination adjustment circuit includes a mask circuit that masks an access request from a bus master which is granted the bus use right, for a given period of time, when the access request from the bus master which is granted the bus use right and an access request from a bus master which is not granted the bus use right compete with each other.

Thus, the bus arbitration circuit according to the first exemplary aspect of the present invention is capable of masking the access request from the bus master which is granted the bus use right, for a given period of time, when the access requests from the bus masters compete with each other. Therefore, the access requests from the bus masters can be arbitrated evenly, while the priority order of the bus masters is maintained.

A second exemplary aspect of the present invention is a bus arbitration method that arbitrates access requests from a plurality of bus masters, including: detecting a state of competition between an access request from a bus master which is granted a bus use right and an access request from a bus master which is not granted the bus use right; masking the access request from the bus master which is granted the bus use right, for a given period of time, when the access request from the bus master which is granted the bus use right and the access request from the bus master which is not granted the bus use right compete with each other; and granting the bus use right to an access request from a higher priority bus master when there are a plurality of access requests from bus masters which are not granted the bus use right.

Thus, the bus arbitration method according to the second exemplary aspect of the present invention is capable of masking the access request from the bus master which is granted the bus use right, for a given period of time, when the access requests from the bus masters compete with each other. Therefore, the access requests from the bus masters can be arbitrated evenly, while the priority order of the bus masters is maintained.

According to exemplary aspects of the present invention, it is possible to provide a bus arbitration circuit and a bus arbitration method that are capable of ensuring an optimal bus use grant period even when bus requests from bus masters are complicated.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing a system configuration including a bus arbitration circuit according to first and second exemplary embodiments of the present invention;

FIG. 2 is a block diagram showing a system configuration including a bus arbitration circuit according to the first exemplary embodiment;

FIG. 3 is a timing diagram illustrating operation of the bus arbitration circuit according to the first exemplary embodiment;

FIG. 4 is a block diagram showing a system configuration including a bus arbitration circuit according to the second exemplary embodiment;

FIG. 5 is a timing diagram illustrating operation of the bus arbitration circuit according to the second exemplary embodiment;

FIG. 6 is a block diagram showing a system configuration including a bus arbitration circuit according to a related art;

FIG. 7 is a timing diagram illustrating operation of the bus arbitration circuit according to the related art (fixed priority method); and

FIG. 8 is a timing diagram illustrating operation of the bus arbitration circuit according to the related art (round robin method).

### DETAILED DESCRIPTION OF THE EXEMPLARY EMBODIMENTS

### First Exemplary Embodiment

Exemplary embodiments of the present invention will be described below with reference to the accompanying drawings.

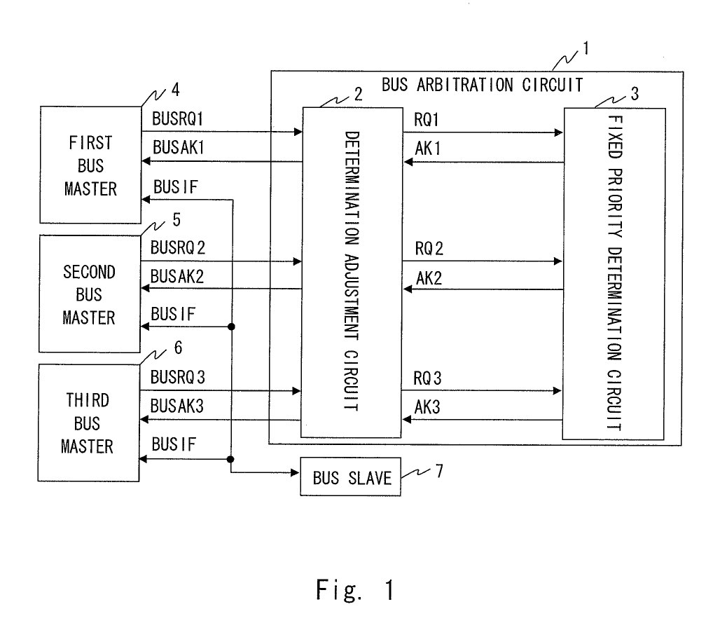

FIG. 1 is a block diagram showing a system configuration including a bus arbitration circuit 1 according to a first exemplary embodiment of the present invention. The bus arbitration circuit 1 according to this exemplary embodiment includes a determination adjustment circuit 2 and a fixed priority determination circuit 3. Upon receiving bus requests (BUSRQn: n=1-3) from first to third bus masters 4, 5, and 6, the determination adjustment circuit 2 determines whether or not to assert RQn (n=1-3) according to the state of bus requests and the status of bus grant at that time. When determining to assert RQn (n=1-3), the determination adjustment circuit 2 asserts RQn (n=1-3) to the fixed priority determination circuit 3.

The fixed priority determination circuit 3 asserts an enabling signal AKn (n=1-3) to a higher priority bus request among the asserted requests RQn (n=1-3). The determination adjustment circuit 2 asserts BUSAKn (n=1-3) according to the state of the received signal AKn (n=1-3), and the first to third bus masters 4, 5, and 6 receiving BUSAKn (n=1-3) access a bus slave 7. Note that reference symbol BUSIF in the drawings represents a communication path between each of the bus masters 4, 5, and 6 and the bus slave 7.

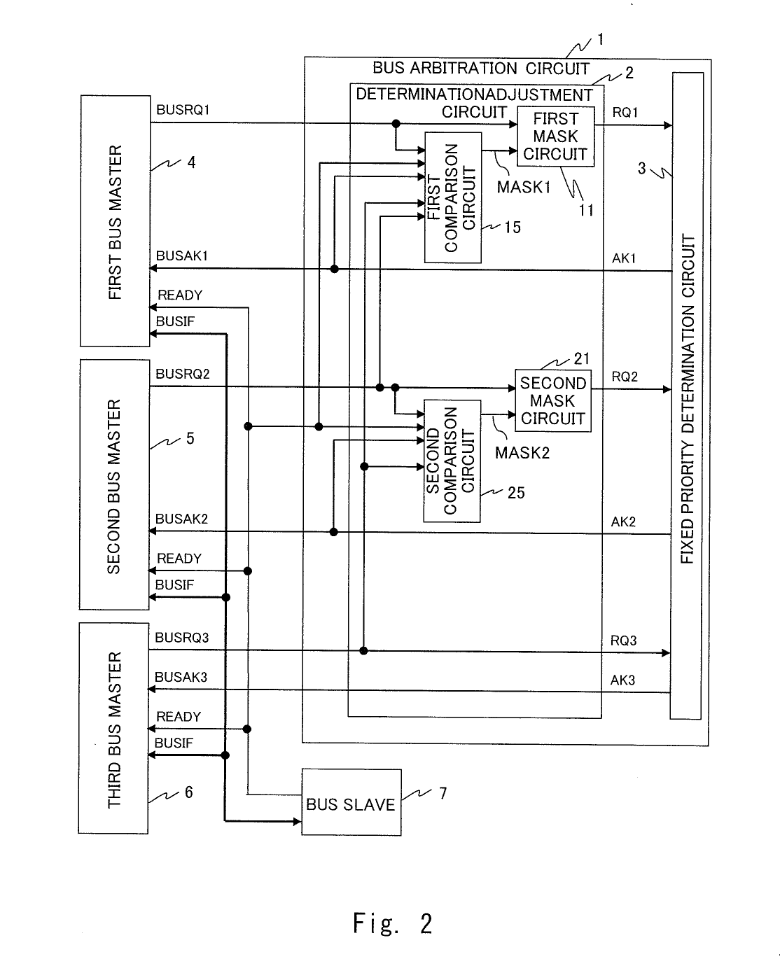

Referring next to FIG. 2, a specific configuration of the determination adjustment circuit 2 will be described. As shown in FIG. 2, the determination adjustment circuit 2 according to this exemplary embodiment includes first and second comparison circuits 15 and 25 and first and second mask circuits 11 and 21. The first and second comparison circuits 15 and 25 recognize a bus master having a bus use right at this time, based on bus grant signals (BUSAKn:n=1-2) and a bus cycle effective signal (READY). Further, when a bus use request from another bus master is detected during a bus cycle period of the bus master having a bus use right, at a subsequent bus arbitration execution timing, a bus request signal (BUSRQn:n=1-2) of the bus master, which is serviced immediately before, is masked for a given period of time until a bus arbitration processing is completed. Accordingly, mask signals (MASKn:n=1-2) are asserted to the first and second mask circuits 11 and 21.

The first mask circuit 11 masks BUSRQ1 during a period when a mask signal (MASK1) is received, and does not transmit RQ1 to the fixed priority determination circuit 3. Similarly, the second mask circuit 21 masks BUSRQ2 during a period when a mask signal (MASK2) is received, and does not transmit RQ2 to the fixed priority determination circuit 3.

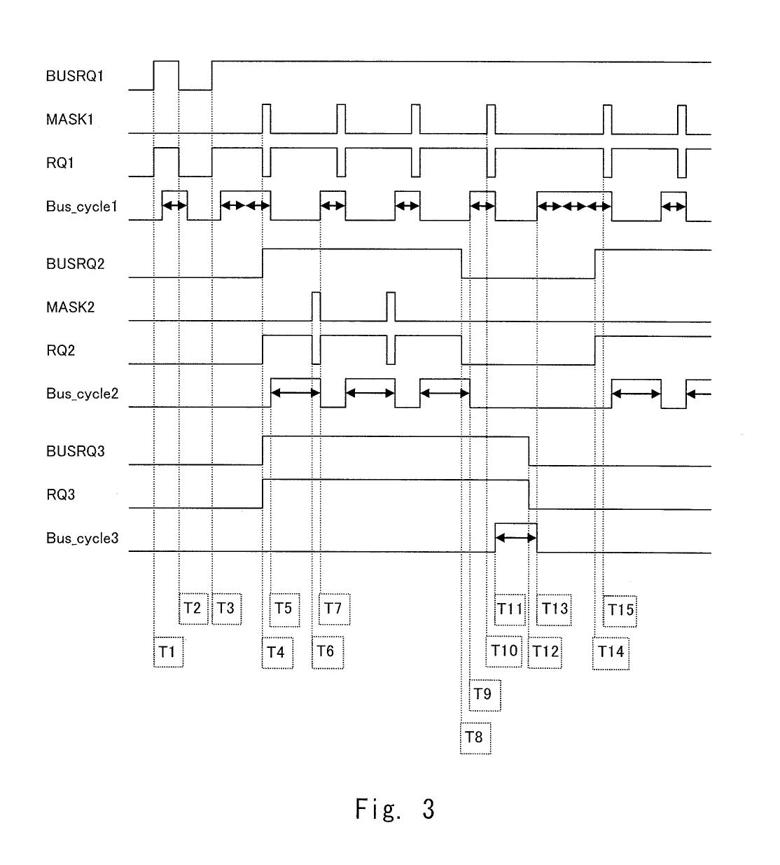

Referring now to FIG. 3, the operation of the bus arbitration circuit 1 according to this exemplary embodiment will be described. FIG. 3 is a timing diagram illustrating the operation of the bus arbitration circuit 1 according to this exemplary embodiment. In FIG. 3, a high level represents an active level.

Herein, the width of each arrow in the pulses each indicating an active period of Bus_cycle_n (n=1-3) represents one bus cycle period of each of the bus masters 4, 5, and 6. In an operation example of FIG. 3, when BUSAKn (n=1-3) is deasserted at the end of the bus cycle period, each of the bus masters 4, 5, and 6 waits for access to the bus until the subsequent BUSAKn (n=1-3) is asserted. The width of Bus_cycle_n is determined based on the state of BUSAKn (n=1-3) and the READY signal.

Referring to FIG. 3, at a timing T1, the first bus master 4 issues a bus request to assert BUSRQ1. At this time, there is no bus request from another bus master, so the first comparison circuit 15 does not operate. The determination adjustment circuit 2 asserts BUSRQ1 directly as RQ1 to the fixed priority determination circuit 3. The fixed priority determination circuit 3 asserts AK1 to the determination adjustment circuit 2, and the determination adjustment circuit 2 asserts BUSAK1 to the first bus master 4. As a result, a bus cycle (a period in which Bus_cycle_1 is high) of the first bus master 4 occurs and the first bus master 4 starts to access the bus slave 7.

At a timing T2, completion of the bus cycle of the first bus master 4 is ensured, and thus the first bus master 4 deasserts BUSRQ1.

At a timing T3, the first bus master 4 issues a bus request again to assert BUSRQ1. At this time, as with the case of the timing T1, there is no bus request from another bus master, so the first comparison circuit 15 does not operate. The determination adjustment circuit 2 asserts BUSRQ1 directly as RQ1 to the fixed priority determination circuit 3. The fixed priority determination circuit 3 asserts AK1 to the determination adjustment circuit 2, and the determination adjustment circuit 2 asserts BUSAK1 to the first bus master 4. As a result, the bus cycle (a period in which Bus_cycle_1 is high) of the first bus master 4 occurs, and the first bus master 4 starts to access the bus slave 7.

At a timing T4, i.e., during a period of a second cycle of the first bus master 4 (as indicated by the second arrow in a pulse of Bus_cycle1), the second bus master 5 and the third bus master 6 issue bus requests to assert BUSRQ2 and BUSRQ3.

The first comparison circuit 15 recognizes a bus request from another bus master during the bus cycle period of the first bus master 4, and asserts the mask signal (MASK1) for masking BUSRQ1 during a subsequent bus arbitration period. The first mask circuit 11 receiving the assertion of the mask signal (MASK1) masks the signal RQ1 during the period.

At a timing T5, RQ1 is deasserted, so the fixed priority determination circuit 3 carries out arbitration of the inputs of RQ2 and RQ3 and grants a bus use right to RQ2 of high priority. As a result, a bus cycle of the second bus master 5 (a period in which Bus_cycle_2 is high) occurs, and the second bus master 5 starts to access the bus slave 7.

At a timing T6, the first bus master 4 and the third bus master 6 issue bus requests. At this time, BUSRQ2 is asserted, so the second comparison circuit 25 asserts the mask signal (MASK2) for masking BUSRQ2 during a subsequent bus arbitration period. The second mask circuit 21 receiving the assertion of the mask signal (MASK2) masks the signal RQ2 during the period.

At a timing T7, RQ2 is deasserted, so the fixed priority determination circuit 3 carries out arbitration of the inputs of RQ1 and RQ3 and grants a bus use right to RQ1 of high priority. As a result, the bus cycle of the first bus master 4 (a period in which Bus_cycle_1 is high) occurs, and the first bus master 4 starts to access the bus slave 7.

At a timing T8, there is no bus request from the second bus master 5, and completion of the bus cycle of the second bus master 5 is ensured. Accordingly, the second bus master 5 deasserts BUSRQ2.

At a timing T9, the fixed priority determination circuit 3 carries out arbitration of the inputs of RQ1 and RQ3 and grants a bus use right to RQ1 of high priority. As a result, the bus cycle of the first bus master 4 (a period in which Bus_cycle_1 is high) occurs, and the first bus master 4 starts to access the bus slave 7.

At a timing T10, the third bus master 6 issues a bus request to assert BUSRQ3. Accordingly, the first comparison circuit 15 asserts the mask signal (MASK1) for masking BUSRQ1 during a subsequent bus arbitration period. The first mask circuit 11 receiving the assertion of the mask signal (MASK1) masks the signal RQ1 during the period.

At a timing T11, the fixed priority determination circuit 3 carries out arbitration of the input of RQ3. At this time, RQ1 is deasserted, so the fixed priority determination circuit 3 grants a bus use right to RQ3. As a result, a bus cycle of the third bus master 6 (a period in which Bus_cycle_3 is high) occurs, and the third bus master 6 starts to access the bus slave 7.

At a timing T12, there is no bus request from the third bus master 6, and completion of the bus cycle of the third bus master 6 is ensured. Accordingly, the third bus master 6 deasserts BUSRQ3.

At a timing T13, the fixed priority determination circuit 3 carries out arbitration of the input of RQ1 and grants a bus use right to RQ1. As a result, the bus cycle of the first bus master 4 (a period in which Bus_cycle_1 is high) occurs, and the first bus master 4 starts to access the bus slave 7.

At a timing T14, i.e., during a period of a third bus cycle of the first bus master 4, the second bus master 5 issues a bus request to assert BUSRQ2.

At a timing T15, the first comparison circuit 15 recognizes a bus request from another bus master during the bus cycle period of the first bus master 4, thereby asserting the mask signal (MASK1) for masking BUSRQ1 during a subsequent bus arbitration period. The first mask circuit 11 receiving the assertion of the mask signal (MASK1) masks the signal RQ1 during the period.

As described above, the bus arbitration circuit 1 according to this exemplary embodiment is capable of masking the access request from the bus master, which is granted a bus use right, for a given period of time, when the access requests from the bus masters 4, 5, and 6 compete with each other. Consequently, the access requests from the bus masters can be arbitrated evenly, while the priority order among the bus masters 4, 5, and 6 is maintained.

Therefore, according to this exemplary embodiment of the present invention, it is possible to provide a bus arbitration circuit capable of ensuring an optimal bus use grant period even when the bus requests from the bus masters are complicated.

Next, a bus arbitration method according to this exemplary embodiment will be described.

The bus arbitration method that arbitrates access requests from multiple bus masters according to this exemplary embodiment includes the steps of:

detecting a state of competition between an access request from a bus master which is granted a bus use right and an access request from a bus master which is not granted the bus use right;

masking the access request from the bus master which is granted the bus use right, for a given period of time, when the access request from the bus master which is granted the bus use right and the access request from the bus master which is not granted the bus use right compete with each other; and

granting the bus use right to an access request from a higher priority bus master, when there are multiple access requests from bus masters which are not granted the bus use right.

Herein, the given period of time for masking the access request from the bus master is, for example, a period of time until the completion of a bus arbitration processing for granting a bus use right to a subsequent bus master.

In the bus arbitration method according to this exemplary embodiment, the bus master granted a bus use right can be recognized based on the bus grant signals output to the multiple bus masters so as to grant a bus use right.

The state of competition between the access requests from the bus masters can be detected using the first and second comparison circuits 15 and 25 shown in FIG. 2, for example.

In the case of masking an access request from a bus master, the first and second mask circuits 11 and 21 shown in FIG. 2, for example, can be used.

In the bus arbitration method according to this exemplary embodiment, when the access requests from the bus masters compete with each other, the access request from the bus master granted the bus use right can be masked for a given period of time. Consequently, the access requests from the bus masters can be arbitrated evenly, while the priority order among the bus masters is maintained.

Therefore, according to this exemplary embodiment, it is possible to provide a bus arbitration method capable of ensuring an optimal bus use grant period even when the bus requests from the bus masters are complicated.

### Second Exemplary Embodiment

Next, a second exemplary embodiment of the present invention will be described. FIG. 1 is a block diagram showing a system configuration including the bus arbitration circuit 1 according to the second exemplary embodiment. As with the bus arbitration circuit 1 according to the first exemplary embodiment, the bus arbitration circuit 1 according to the second exemplary embodiment includes the determination adjustment circuit 2 and the fixed priority determination circuit 3. The determination adjustment circuit 2 of the bus arbitration circuit 1 according to this exemplary embodiment differs from that of the first exemplary embodiment.

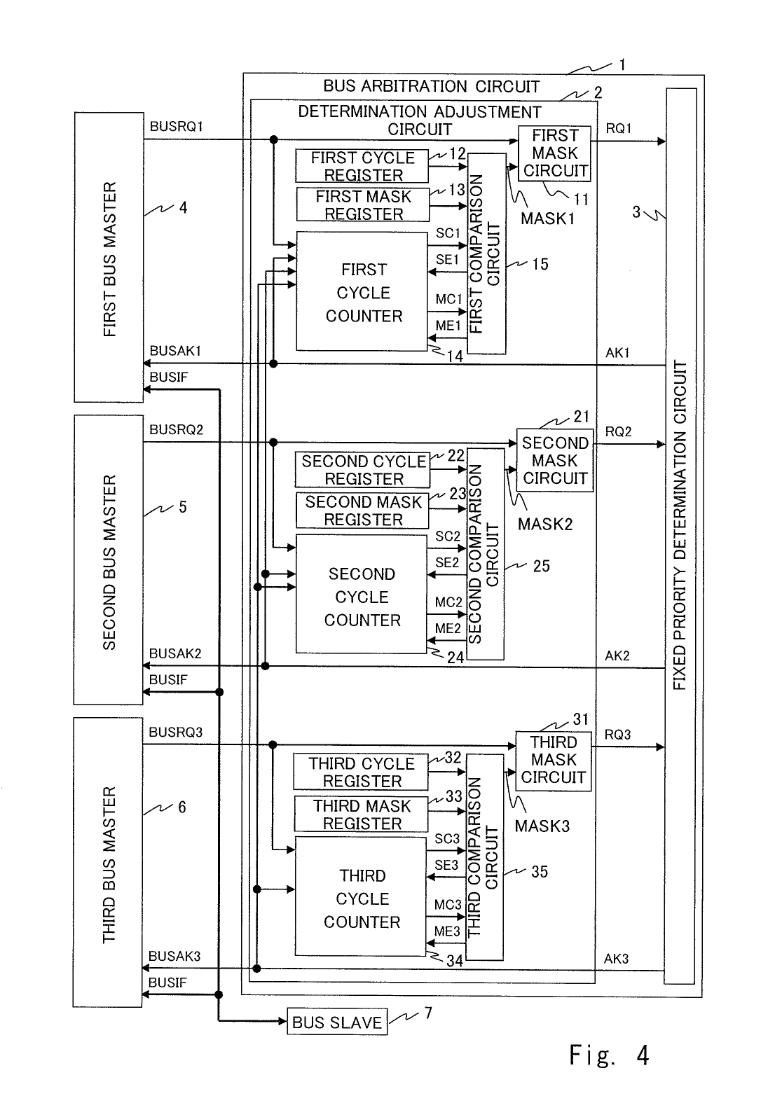

Referring to FIG. 4, a specific configuration of the determination adjustment circuit 2 will be described. It is assumed in this exemplary embodiment that n=1-3.

As shown in FIG. 4, the determination adjustment circuit 2 includes first to third mask circuits 11, 21, and 31, first to third cycle registers 12, 22, and 23, first to third mask register 13, 23, and 33, first to third cycle counters 14, 24, and 34, and first to third comparison circuits 15, 25, and 35.

The first cycle register 12 is a rewritable register that sets a period of time in which the execution of service of target bus request is continuously granted, when the bus requests (BUSRQn) compete with each other. The first mask register 13 is a rewritable register that sets a period of time in which the target bus request is not transmitted to the fixed priority determination circuit 3, when the bus requests (BUSRQn) compete with each other.

The first cycle counter 14 is a counter that counts one cycle period in which the target bus master granted the bus use request accesses the bus slave 7, as one count, when the bus request from the target bus master and the bus request from another bus master compete with each other and when the bus use grant for the target bus master is started.

The first cycle counter 14 always notifies a count value to the first comparison circuit 15 as a cycle count value (SC1), and upon receiving an assertion of a cycle count coincidence signal (SE1) from the first comparison circuit 15, the first cycle counter 14 starts operation to count a mask count value (MC1) by using the assertion input as a trigger.

The mask count value MC1 is a counter value from the first cycle counter 14 which is a counter that counts one access cycle period of the bus master as one count. Upon receiving an assertion of a mask count coincidence signal (ME1) from the first comparison circuit 15, the first cycle counter 14 is initialized.

The first comparison circuit 15 compares a set value of the first cycle register 12 with the cycle count value (SC1), and asserts the signal SE1 when the count value matches the set value. Further, the first comparison circuit 15 compares a set value of the first mask register 13 with the mask count value (MC1), and asserts the signal ME1 when the count value matches the set value. During the period after the assertion of the signal SE1 until the assertion of the signal ME1, the first comparison circuit 15 asserts the mask signal (MASK1) to the first mask circuit 11.

During the period in which the mask signal (MASK1) is received, the first mask circuit 11 masks BUSRQ1 and does not transmit RQ1 to the fixed priority determination circuit 3.

The above description is made, by way of example, of the circuit including the first mask circuit 11, the first cycle register 12, the first mask register 13, the first cycle counter 14, and the first comparison circuit 15. Herein, the circuit including the second mask circuit 21, the second cycle register 22, the second mask register 23, the second cycle counter 24, and the second comparison circuit 25 and the circuit including the third mask circuit 31, the third cycle register 32, the third mask register 33, the third cycle counter 34, and the third comparison circuit 35 as shown in FIG. 4 have the same configuration as that of the circuit including the first mask circuit 11 as described above.

Next, the fixed priority determination circuit 3 will be described. The fixed priority determination circuit 3 asserts the enabling signal AKn to a higher priority bus request among the asserted requests RQn. The determination adjustment circuit 2 asserts BUSAKn according to the state of the received enabling signal AKn, and the first to third bus masters 4, 5, and 6 receiving BUSAKn access the bus slave 7. Note that BUSIF represents a communication path between each of the bus masters 4, 5, and 6, and the bus slave 7.

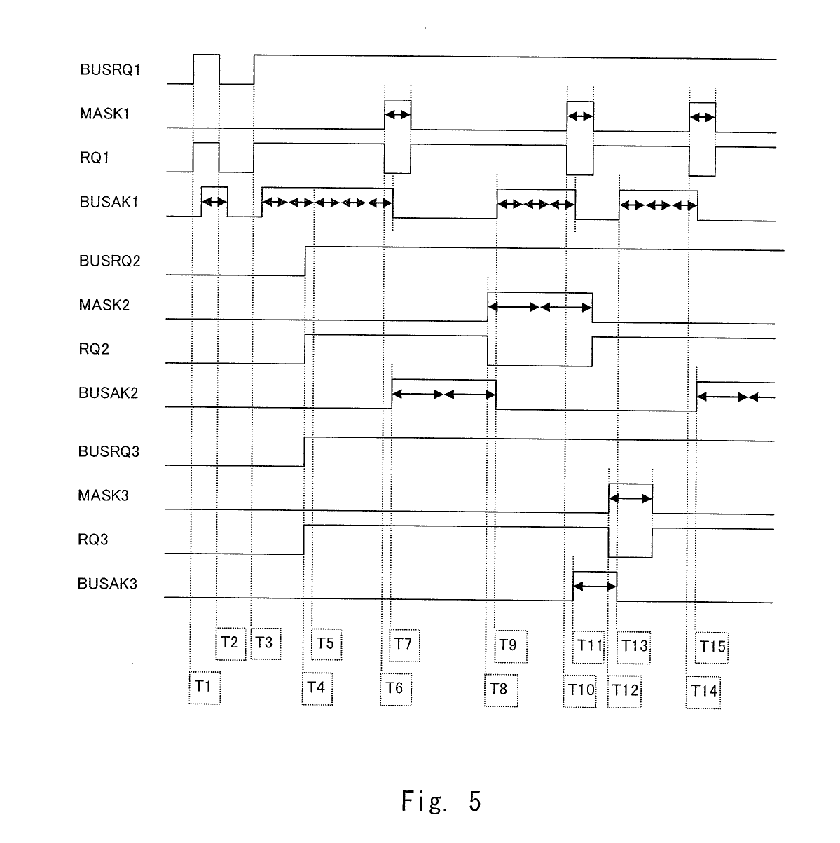

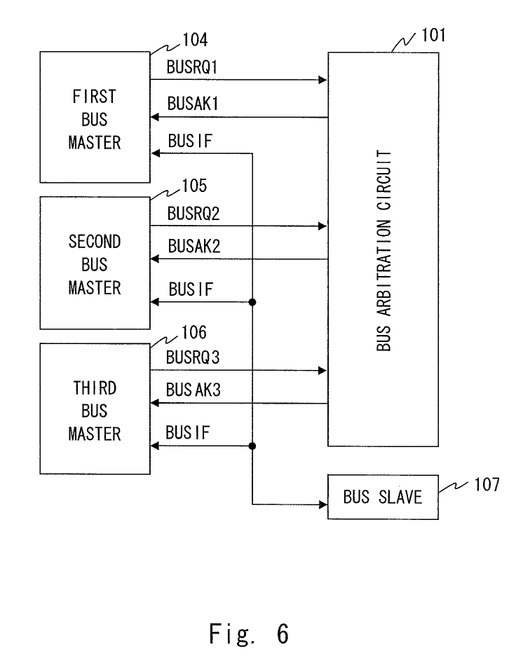

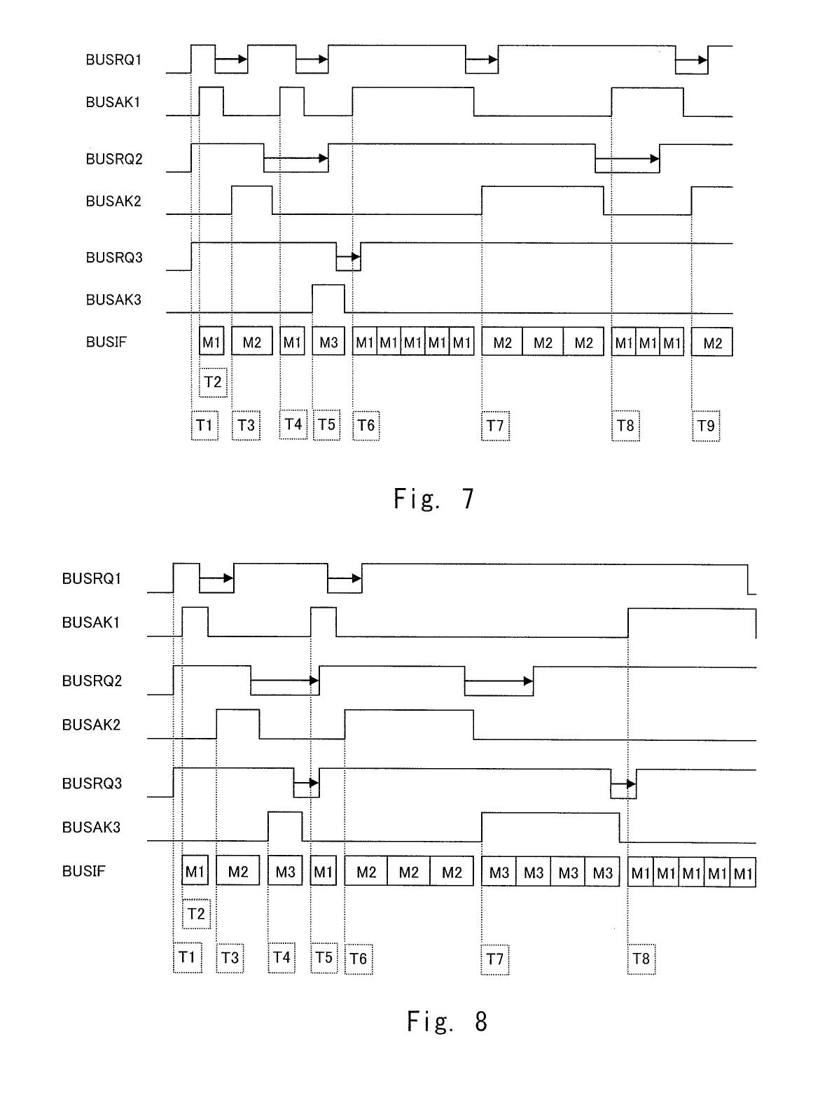

Referring next to FIG. 5, the operation of the bus arbitration circuit 1 according to this exemplary embodiment will be described. FIG. 5 is a timing diagram illustrating the operation of the bus arbitration circuit 1 according to this exemplary embodiment. In FIG. 5, a high level represents an active level.

Herein, the width of each arrow in the pulses each indicating an active period of BUSAKn represents one bus cycle period of each of the bus masters 4, 5, and 6. As an exemplary operation shown in FIG. 5, when BUSAKn is deasserted at the end of the bus cycle period, each of the bus masters 4, 5, and 6 waits for access to the bus until a subsequent assertion of BUSAKn.

Note that set values of the cycle registers 12, 22, and 32 and set values of the mask registers 13, 23, and 33 are set as follows, for example. These values can be arbitrarily set and adjusted to optimize the arbitration processing of the bus arbitration circuit 1.

The first cycle register 12=“3” (three bus cycles are permitted at a time).

The first mask register 13=“1” (the request BUSRQ1 is masked for one bus cycle period).

The second cycle register 22=“2” (two bus cycles are permitted at a time).

The second mask register 23=“2” (the request BUSRQ2 is masked for two bus cycle periods).

The third cycle register 32=“1” (one bus cycle is permitted at a time).

The third mask register 33=“1” (the request BUSRQ3 is masked for one bus cycle period).

Referring to FIG. 5, at the timing T1, the first bus master 4 issues a bus request to assert BUSRQ1. At this time, there is no bus request from another bus master, so the first comparison circuit 15 does not operate. The determination adjustment circuit 2 asserts BUSRQ1 as RQ1 to the fixed priority determination circuit 3. The fixed priority determination circuit 3 asserts AK1, and the determination adjustment circuit 2 asserts BUSAK1.

At the timing T2, completion of the bus cycle of the first bus master 4 is ensured, and thus the first bus master 4 deasserts BUSRQ1. As a result, BUSAK1 is deasserted.

At the timing T3, the first bus master 4 issues a bus request again to assert BUSRQ1. In this case, as with the case of the timing T1, there is no bus request from another bus master, so the first comparison circuit 15 does not operate. The determination adjustment circuit 2 asserts BUSRQ1 directly as RQ1 to the fixed priority determination circuit 3. The fixed priority determination circuit 3 asserts AK1, and the determination adjustment circuit 2 asserts BUSAK1.

At the timing T4, i.e., during the period of the second cycle of the first bus master 4 (as indicated by the second arrow in the assert pulse of BUSAK1), the second bus master 5 and the third bus master 6 issue bus requests to assert BUSRQ2 and BUSRQ3.

At the timing T5, i.e., at the time when the second bus cycle of the first bus master 4 is completed, the first cycle counter 14 of the determination adjustment circuit 2 starts counting the number of bus cycles of the first bus master 4.

At the timing T6, the bus cycle of the first bus master 4 occurs three times and the count value (SC1=3) of the first cycle counter 14 matches the set value (=3) of the first cycle register 12. Accordingly, the first comparison circuit 15 asserts SE1. The first cycle counter 14 receiving the assertion of SE1 starts counting of the mask count value (MC1). The first comparison circuit 15 asserts the mask signal (MASK1) until the set value (=1) of the first mask register 13 matches the mask count value (MC1), i.e., for one bus cycle period. Then, when the set value (=1) of the first mask register 13 matches the mask count value (MC1), the first comparison circuit 15 asserts ME1 and initializes the first cycle counter 14. The first mask circuit 11 masks the assertion of RQ1 for the fixed priority determination circuit 3 for the mask period.

At the timing T7, RQ1 is deasserted, so the fixed priority determination circuit 3 carries out arbitration of the inputs of RQ2 and RQ3 and asserts AK2 to RQ2 of high priority. As a result, BUSAK2 is asserted. At this time, the second cycle counter 24 of the determination adjustment circuit 2 starts counting the number of bus cycles of the second bus master 5.

At the timing T8, the bus cycle of the second bus master 5 occurs twice and the count value (SC2=2) of the second cycle counter 24 matches the set value (=2) of the second cycle register 22. Accordingly, the second comparison circuit 25 asserts SE2. The second cycle counter 24 receiving the assertion of SE2 starts counting of the mask count value (MC2). The second comparison circuit 25 asserts the mask signal (MASK2) until the set value (=2) of the second mask register 23 matches the mask count value (MC2), i.e., for two bus cycle periods. Then, when the set value (=2) of the second mask register 23 matches the mask count value (MC2), the second comparison circuit 25 asserts ME2 and initializes the second cycle counter 24. The second mask circuit 21 masks the assertion of RQ2 to the fixed priority determination circuit 3 for the mask period.

At the timing T9, RQ2 is deasserted, so the fixed priority determination circuit 3 carries out arbitration of the inputs of RQ1 and RQ3 and asserts AK1 to RQ1 of high priority. As a result, BUSAK1 is asserted. At this time, the first cycle counter 14 of the determination adjustment circuit 2 starts counting the number of bus cycles of the first bus master 4.

At the timing T10, the bus cycle of the first bus master 4 occurs three times and the count value (SC1=3) of the first cycle counter 14 matches the set value (=3) of the first cycle register 12. Accordingly, the first comparison circuit 15 asserts SE1. The first cycle counter 14 receiving the assertion of SE1 starts counting of the mask count value (MC1). The first comparison circuit 15 asserts the mask signal (MASK1) until the set value (=1) of the first mask register 13 matches the mask count value (MC1), i.e., for one bus cycle period. Then, when the set value (=1) of the first mask register 13 matches the mask count value (MC1), the first comparison circuit 15 asserts ME1 and initializes the first cycle counter 14. The first mask circuit 11 masks the assertion of RQ1 to the fixed priority determination circuit 3 for the mask period.

At the timing T11, RQ1 is deasserted, so the fixed priority determination circuit 3 carries out arbitration of the input of RQ3 and asserts AK3 to RQ3. As a result, BUSAK3 is asserted. At this time, the third cycle counter 34 of the determination adjustment circuit 2 starts counting the number of bus cycles of the third bus master 6.

At the timing T12, the bus cycle of the third bus master 6 occurs once and the count value (SC3=1) of the third cycle counter 34 matches the set value (=1) of the third cycle register 32. Accordingly, the third comparison circuit 35 asserts SE3. The third cycle counter 34 receiving the assertion of SE3 starts counting of the mask count value (MC3). The third comparison circuit 35 asserts the mask signal (MASK3) until the set value (=1) of the third mask register 33 matches the mask count value (MC3), i.e., for one bus cycle period. Then, when the set value (=1) of the third mask register 33 matches the mask count value (MC3), the third comparison circuit 35 asserts ME3 and initializes the third cycle counter 34. The third mask circuit 31 masks the assertion of RQ3 to the fixed priority determination circuit 3 for the mask period.

At the timing T13, RQ3 is deasserted, so the fixed priority determination circuit 3 carries out arbitration of the inputs of RQ1 and RQ2 and asserts AK1 to RQ1 of high priority. As a result, BUSAK1 is asserted. At this time, the first cycle counter 14 of the determination adjustment circuit 2 starts counting the number of bus cycles of the first bus master 4.

At the timing T14, the bus cycle of the first bus master 4 occurs three times and the count value (SC1=3) of the first cycle counter 14 matches the set value 3) of the first cycle register 12. Accordingly, the first comparison circuit 15 asserts SE1. The first cycle counter 14 receiving the assertion of SE1 starts counting of the mask count value (MC1). The first comparison circuit 15 asserts the mask signal (MASK1) until the set value (=1) of the first mask register 13 matches the mask count value (MC1), i.e., for one bus cycle period. Then, when the set value (=1) of the first mask register 13 matches the mask count value (MC1), the first comparison circuit 15 asserts ME1 and initializes the first cycle counter 14. The first mask circuit 11 masks the assertion of RQ1 to the fixed priority determination circuit 3 for the mask period.

At the timing T15, RQ1 is deasserted, so the fixed priority determination circuit 3 carries out arbitration of the inputs of RQ2 and RQ3 and asserts AK2 to RQ2 of high priority. As a result, BUSAK2 is asserted. At this time, the second cycle counter 24 of the determination adjustment circuit 2 starts counting the number of bus cycles of the second bus master 5.

As described above, the bus arbitration circuit 1 according to this exemplary embodiment is capable of masking the access request from the bus master, which is granted a bus use right, for a given period of time, when the access requests from the bus masters 4, 5, and 6 compete with each other. Consequently, the access requests from the bus masters can be arbitrated evenly, while the priority order among the bus masters 4, 5, and 6 is maintained.

Therefore, according to this exemplary embodiment of the present invention, it is possible to provide a bus arbitration circuit capable of ensuring an optimal bus use grant period even when the bus requests from the bus masters are complicated. Further, the set values of the cycle registers and the set values of the mask registers are changed, for example, thereby making it possible to appropriately change the distribution ratio of the bus service depending on a program. Accordingly, the bus arbitration circuit can be easily optimized even if the system configuration is changed. Also in the same system, the distribution ratio of the bus service can be dynamically changed according to the processing state, and therefore an optimal bus service can be achieved constantly.

Next, a bus arbitration method according to this exemplary embodiment will be described.

The bus arbitration method according to this exemplary embodiment which arbitrates access requests from multiple bus masters includes the steps of:

detecting a state of competition between an access request from a bus master which is granted a bus use right and an access request from a bus master which is not granted the bus use right;

masking the access request from the bus master which is granted the bus use right, for a given period of time, when the access request from the bus master which is granted the bus use right and the access request from the bus master which is not granted the bus use right compete with each other, the access request from the bus master being masked when a period in which the bus use right is continuously granted to the same bus master among the multiple bus masters reaches a predetermined period; and

granting the bus use right to an access request from a higher priority bus master when there are multiple access requests from bus masters which are not granted the bus use right.

Herein, the period of time in which the bus use right is continuously granted corresponds to a bus cycle of a bus master granted the bus use right. The period of time in which the access request from the bus master is masked is a given period of time corresponding to the bus cycle of the bus master whose access request is masked. The period of time in which the bus use right is continuously granted and the period of time in which the access request from the bus master is masked can be set for each of the multiple bus masters.

The state of competition between the access requests from the bus masters can be detected using the first to third comparison circuits 15, 25, and 35 shown in FIG. 4, for example. In the case of masking an access request from a bus master, the first to third mask circuits 11, 21, and 31 shown in FIG. 4, for example, can be used.

Also in the bus arbitration method according to this exemplary embodiment, when the access requests from the bus masters compete with each other, the access request from the bus master granted the bus use right can be masked for a given period of time. Consequently, the access requests from the bus masters can be arbitrated evenly, while the priority order of the bus masters is maintained.

Therefore, according to this exemplary embodiment of the present invention, it is possible to provide a bus arbitration method capable of ensuring an optimal bus use grant period even when the bus requests from the bus masters are complicated.

While in the first and second exemplary embodiments, the case where three bus masters are provided is described by way of example, the present invention is applicable to the case where two or more bus masters are provided. In this case, the number of circuits for masking a bus request from a bus master can be determined depending on the number of bus masters.

The first and second exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A bus arbitration circuit comprising:
a fixed priority determination circuit that grants a bus use right to an access request from a higher priority bus master among access requests from a plurality of bus masters; and
a determination adjustment circuit that determines whether or not to assert the access request from the plurality of bus masters to the fixed priority determination circuit,
wherein the determination adjustment circuit includes a mask circuit that masks an access request from a bus master which is granted the bus use right, for a given period of time, when the access request from the bus master which is granted the bus use right and an access request from a bus master which is not granted the bus use right compete with each other.

2. The bus arbitration circuit according to claim 1, wherein the given period of time in which the mask circuit masks the access request from the bus masters is a period of time until the fixed priority determination circuit completes a bus arbitration processing for granting the bus use right to a subsequent bus master.

3. The bus arbitration circuit according to claim 1, wherein the determination adjustment circuit recognizes the bus master granted the bus use right based on bus grant signals output from the fixed priority determination circuit to the plurality of bus masters so as to grant the bus use right.

4. The bus arbitration circuit according to claim 1, wherein
the determination adjustment circuit includes a comparison circuit that compares the bus grant signals output to the plurality of bus masters, and
the comparison circuit outputs a mask signal to the mask circuit based on a comparison result of the bus grant signals.

5. The bus arbitration circuit according to claim 1, wherein the determination adjustment circuit masks the access request from the bus masters when a period of time in which the fixed priority determination circuit continuously grants the bus use right reaches a given period of time.

6. The bus arbitration circuit according to claim 5, wherein the period of time in which the fixed priority determination circuit continuously grants the bus use right corresponds to a bus cycle of a bus master granted the bus use right.

7. The bus arbitration circuit according to claim 5, wherein the period of time in which the access request from the bus masters is masked is a given period of time corresponding to a bus cycle of a bus master whose access request is masked.

8. The bus arbitration circuit according to claim 5, wherein the period of time in which the fixed priority determination circuit continuously grants the bus use right and the period of time in which the mask circuit masks the access request from the bus masters can be set for each of the plurality of bus masters.

9. The bus arbitration circuit according to claim 5, wherein the determination adjustment circuit includes:
a mask register that stores a set value of a period of time in which the access request from the bus masters is masked;
a cycle register that stores a set value of a period of time in which the fixed priority determination circuit can continuously grant the bus use right;
a cycle counter that counts a value corresponding to a mask period in which the access request from the bus masters is masked and a value corresponding to a use grant period in which the fixed priority determination circuit continuously grants the bus use right; and
a comparison circuit that compares the set value stored in the mask register with the value corresponding to the mask period counted by the cycle counter, and compares the set value stored in the cycle register with the value corresponding to the use grant period counted by the cycle counter.

10. A bus arbitration method that arbitrates access requests from a plurality of bus masters, comprising:
detecting a state of competition between an access request from a bus master which is granted a bus use right and an access request from a bus master which is not granted the bus use right;
masking the access request from the bus master which is granted the bus use right, for a given period of time, when the access request from the bus master which is granted the bus use right and the access request from the bus master which is not granted the bus use right compete with each other; and
granting the bus use right to an access request from a higher priority bus master when there are a plurality of access requests from bus masters which are not granted the bus use right.

11. The bus arbitration method according to claim 10, wherein the given period of time in which the access request from the bus master is masked is a period of time until a bus arbitration processing for granting the bus use right to a subsequent bus master is completed.

12. The bus arbitration method according to claim 10, further comprising recognizing a bus master granted the bus use right based on bus grant signals output to the plurality of bus masters so as to grant the bus use right.

13. The bus arbitration method according to claim 10, wherein the access request from the bus masters is masked when a period of time in which the bus use right is continuously granted reaches a given period of time.

14. The bus arbitration method according to claim 13, wherein the period of time in which the bus use right is continuously granted corresponds to a bus cycle of the bus master granted the bus use right.

15. The bus arbitration method according to claim 13, wherein the period of time in which the access request from the bus masters is masked is a given period of time corresponding to a bus cycle of the bus master whose access request is masked.

16. The bus arbitration method according to claim 13, wherein the period of time in which the bus use right is continuously granted and the period of time in which the access request from the bus masters is masked can be set for each of the plurality of bus masters.
